(19) United States
(12) Patent Application Publication
(10) Pub. No.: US 2016/0306083 A1
(43) Pub. Date: Oct. 20, 2016

(54) QUICK SPHERE WITH EASY SNAP ENGAGEMENT AND AUDIBLE INDICATOR

(71) Applicant: IZI MEDICAL PRODUCTS, LLC, OWINGS MILLS, MD (US)

(72) Inventors: NELSON L. HULDIN, ALEXANDRIA, VA (US); ADAM T. BEAN, BALTIMORE, MD (US)

(21) Appl. No.: 14/690,862

(22) Filed: Apr. 20, 2015

(51) Int. Cl. G02B 5/134

(52) U.S. Cl. CPC G02B 5/134

(57) ABSTRACT

Described is a device comprising a retro-reflective marker comprising a core comprising a body portion, and a mounting recess extending into the body portion. The mounting recess comprises one or more flexible interior engagement structures configured for snap-on engagement with one or more complementary exterior engagement structures of a mounting post. The flexible interior engagement structures are configured so that when the retro-reflective marker is mounted onto the mounting post by direct axial application, the flexible interior engagement structures are deflected by the one or more complementary exterior engagement structures as the flexible interior engagement structures move past the one or more complementary exterior engagement structures and spring back to a relaxed position to thereby engage the one or more complementary exterior engagement structures so that the retro-reflective marker is mounted in a secured configuration on the mounting post.

### CROSS-REFERENCE TO RELATED APPLICATIONS

This application claims benefit of priority to U.S. Provisional Patent Application No. 61/565,099 to Shafer, entitled NOVEL SNAP-ON-SPHERE, filed Nov. 30, 2011, which is incorporated herein by reference in its entirety. This application makes reference to U.S. Pat. No. 8,662,684 B2 entitled “RADIOPAQUE CORE,” filed Feb. 29, 2012, U.S. Pat. No. 8,668,345 B2 entitled “RETRO-REFLECTIVE MARKER WITH SNAP ON THREADED POST,” filed Feb. 29, 2012, U.S. Pat. No. 8,668,342 B2 entitled “MATERIAL THICKNESS CONTROL OVER RETRO-REFLECTIVE MARKER,” filed Feb. 29, 2012, U.S. Pat. No. 8,646,921 B2 entitled “REFLECTIVE MARKER BEING RADIO-OPAQUE FOR MRI,” filed Feb. 29, 2012, U.S. Pat. No. 8,651,274 B2 entitled “PACKAGING FOR RETRO-REFLECTIVE MARKERS,” filed Feb. 29, 2012, U.S. Pat. No. 8,672,490 B2 entitled “HIGH REFLECTIVITY RETRO-REFLECTIVE MARKER,” filed Feb. 29, 2012, U.S. Pat. No. 8,641,210 B2 entitled “RETRO-REFLECTIVE MARKER INCLUDING COLORED MOUNTING PORTION,” filed Feb. 29, 2012, U.S. Pat. No. 8,668,344 B2 entitled “MARKER SPHERE INCLUDING EDGED OPENING TO AID IN MOLDING,” filed Feb. 29, 2012, U.S. Pat. No. 8,668,343 B2 entitled “REFLECTIVE MARKER WITH ALIGNMENT FEATURE,” filed Feb. 29, 2012, the entire content and disclosures of which are incorporated herein by reference in their entirety.

### BACKGROUND

1. Field of the Invention

The present invention relates to retro-reflective markers for image-guided surgery.

2. Related Art

Systems for obtaining coordinates of a point or points of interest include marker-tracking systems. Such marker-tracking systems typically rely on objects having one or more markers affixed thereto. The markers that are affixed to the object may be active markers (e.g., light-emitting diode markers), passive markers (e.g., retro-reflective markers) or a combination of active and passive markers. In a medical application context, such as image-guided surgery, a user (e.g., a doctor) touches the surface of interest (e.g., a surface of a patient's body) using the distal tip of an object (e.g., a probe or a surgical instrument). A marker-sensing device (e.g., a pair of cameras) views the marker(s) affixed to the object. On the basis of the known locations of the cameras and the location(s) of the marker(s) as seen by each camera, such systems calculate the three-dimensional coordinates of the marker(s). Then, on the basis of the known relationship between the location(s) of the marker(s) and the location of the object tip, the marker-tracking system determines the coordinates of the object's tip. With the object's tip on the surface, those coordinates also correspond to the coordinates of the surface at that point.

### SUMMARY

According to a first broad aspect, the present invention provides a device comprising a retro-reflective marker comprising a core comprising a body portion, and a mounting recess extending into the body portion. The mounting recess comprises one or more flexible interior engagement structures configured for snap-on engagement with one or more complementary exterior engagement structures of a mounting post. The flexible interior engagement structures are configured so that when the retro-reflective marker is mounted onto the mounting post by direct axial application, the flexible interior engagement structures are deflected by the one or more complementary exterior engagement structures as the flexible interior engagement structures move past the one or more complementary exterior engagement structures and spring back to a relaxed position to thereby engage the one or more complementary exterior engagement structures so that the retro-reflective marker is mounted in a secured configuration on the mounting post.

According to a second broad aspect, the present invention provides The device comprising a device comprising a retro-reflective marker comprising a core comprising a body portion, and a mounting recess extending into the body portion of the core. The mounting recess comprises one or more flexible snap-on interior engagement structures configured to releasably engage one or more complementary exterior engagement structures of a mounting post when the retro-reflective marker is in a secured configuration on the mounting post. The releasable engagement of one or more interior engagement structures of the mounting recess with one or more complementary exterior engagement structures of the mounting post generates an audible clicking sound. Multiple audible clicks are generated as the mounting post axially extends into the mounting recess, and cessation of the audible clicking sound indicates that the retro-reflective marker is in a secured configuration on the mounting post.

According to a third broad aspect, the present invention provides a device comprising a retro-reflective marker comprising a core comprising a body portion, and a mounting recess extending into the body portion of the core. The mounting recess comprises one or more interior engagement structures configured to releasably engage one or more complementary exterior engagement structures of a mounting post when the retro-reflective marker is in a secured configuration on the mounting post. The mounting recess comprises internal gaps between one or more interior surface regions of the mounting recess and one or more protruding surface regions of a mounting post when the retro-reflective marker is mounted in the secured configuration on the mounting post. The retro-reflective marker and the mounting post have a stop contact between a bottom surface of the retro-reflective marker and a support surface of the mounting post and this is the only stop contact between the retro-reflective marker and the mounting post.

### BRIEF DESCRIPTION OF THE DRAWINGS

The accompanying drawings, which are incorporated herein and constitute part of this specification, illustrate exemplary embodiments of the present invention and, together with the general description given above and the detailed description given below, serve to explain the features of the present invention.

FIG. 1 is a perspective view of a retro-reflective marker sphere according to one embodiment of the present invention.

FIG. 2 is an exploded view of the retro-reflective marker sphere of FIG. 1 according to one embodiment of the present invention.

FIG. 3 is a bottom plan view of the retro-reflective marker sphere of FIG. 1 according to one embodiment of the present invention.

FIG. 4 is a side-view of the retro-reflective marker sphere of FIG. 1 illustrating a structure of a mounting recess with a corrugated engagement structure according to one embodiment of the present invention.

FIG. 5 is a side-view of retro-reflective marker sphere core ball showing the internal structure of mounting recess with helical screw thread engagement structure, along with the dimensional details of the helical screw thread engagement structure according to one embodiment of the present invention.

FIG. 6 is a perspective view of a threaded mounting post on an arm of the medical device according to one embodiment of the present invention.

FIG. 7 is a side-view of the retro-reflective marker sphere of FIG. 5 mounted onto the mounting pin of FIG. 6 according to one embodiment of the present invention.

FIG. 8. is a side-view of the retro-reflective marker sphere of FIG. 4 mounted onto the mounting pin of FIG. 6 according to one embodiment of the present invention.

FIG. 9 is a blow-up view of the region along line A-A in FIG. 7 according to one embodiment of the present invention.

FIG. 10 is an illustration showing dimensional parameters of the mounting recess in FIG. 5 according to one embodiment of the present invention.

FIG. 11 is a bottom-view illustration of the retro-reflective marker sphere core ball in FIG. 10 according to one embodiment of the present invention.

FIG. 12 is a side-view of the retro-reflective marker sphere core ball in FIG. 10 according to one embodiment of the present invention.

FIG. 13 illustrates geometrical details of the region along line Z-Z in FIG. 12 according to one embodiment of the present invention.

### DETAILED DESCRIPTION OF THE PREFERRED EMBODIMENTS

### Definitions

Where the definition of terms departs from the commonly used meaning of the term, applicant intends to utilize the definitions provided below, unless specifically indicated.

For purposes of the present invention, it should be noted that the singular forms, “a,” “an” and “the,” include reference to the plural unless the context as herein presented clearly indicates otherwise.

For purposes of the present invention, directional terms such as “top,” “bottom,” “upper,” “lower,” “above,” “below,” “left,” “right,” “horizontal,” “vertical,” “up,” “down,” etc., are used merely for convenience in describing the various embodiments of the present invention. The embodiments of the present invention may be oriented in various ways. For example, the diagrams, apparatuses, etc., shown in the drawing figures may be flipped over, rotated by 90° in any direction, reversed, etc.

For purposes of the present invention, the term “alignment indicator” refers to a symbol or other type of indicator on one or more sides of a mounting base of a retro-reflective marker sphere that may be used to determine if the retro-reflective marker sphere is aligned properly on its mounting post. Examples of alignment indicators include: lines, dots, letters, numbers, stars, shapes, etc.

For purposes of the present invention, the term “audible” refers to a sound that may be heard by an human being having normal hearing.

For purposes of the present invention, the term “corrugated engagement” refers to complementary shaped surface features comprising alternating peaks and valleys or ribs and groves or any type of structural protrusions arranged with inter-locking gap in between.

For purposes of the present invention, the term “corrugated” describes a structure or a physical region comprising a plurality of surface elevations or protrusions with alternating depressions or indentations and depressions or indentations such as peaks and valleys or ribs and grooves.

For purposes of the present invention, the term “corrugations” refer to one or more individual surface elevations and/or depressions on a corrugated surface or structure.

For purposes of the present invention, the term “coupling” refers to engagement elements complementary shapes, shaped with respect to each other such that when placed in proximity or pushed together the first engagement element and the second engagement element join or mate, i.e., fit together. Examples of coupling first and second engagement elements include a pin and a blind hole; a pin and an aperture; a tongue and a notch; a ridge and a groove.

For purposes of the present invention, the term “engage” refers to a contacting and/or interlocking interaction between two or more engagement structures.

For purposes of the present invention, the term “dimensional stability” refers to a condition or a state wherein a main object does not move relative to a reference object to which the main object is coupled to or attachably and/or releasably engaged. In select embodiments of the present invention, this may include minimal or no spacial movement (such as in the x-direction, y-direction, or z-direction) of the main object relative to a reference object, such as the disclosed mounting pin after the main object has been mounted thereto. Dimensional stability may also refer to the secure placement of a main object onto a reference object.

This requires that the body portion of the core ball into which the mounting recess extends, is made with soft high-flex material that is hard enough to ensure dimensional stability and secure placement of the marker sphere on the mounting post while being soft enough to allow interior engagement threads to deflect past exterior threads on a mounting post and snap back to normal from the deflected position without shearing off.

For purposes of the present invention, the term “direct axial application” refers to placement, attachment, fastening performed through application of force along the axial direction.

For purposes of the present invention, the term “durometer” refers to one of several measures of the hardness of a material. Hardness maybe defined as a material's resistance to permanent indentation.

For purposes of the present invention, the term “engagement structure” refers to a structure on a first object, such as a retro-reflective marker sphere or a post, that is shaped to engage one or more engagement structures on a second object, such as a post or a retro-reflective marker sphere. Examples of engagement structures include interior screw threads, exterior screw threads, ledges, tabs, recesses, rims, etc.

For purposes of the present invention, the term “engaging complementary surfaces” refers to a surface region disposed on the interior or exterior of a first object, such as a retro-reflective marker sphere or a post, that is shaped to engage one or more surface regions dispoed on the interior or exterior of a second object, such as a post or a retro-reflective marker sphere. Examples of complementary engagement surfaces include interior corrugations, exterior corrugations, interior screw threads, exterior screw threads, ledges, tabs, recesses, rims, etc

For purposes of the present invention, the term “exterior snap-on engagement structure” refers to an engagement structure on an exterior surface of an object, such as a mounting post.

For purposes of the present invention, the term “generally hemispherical” refers to an object that is at least 50% hemispherical in shape over its surface, such as a retro-reflective marker sphere upper or lower retro-reflective covering. An object that is generally hemispherical in shape may include one or more openings and/or recesses. An object that is generally hemispherical in shape, such as a retro-reflective marker sphere upper or lower retro-reflective covering, may be comprised of one piece or two or more pieces. An object that is generally hemispherical in shape may be hollow or solid.

For purposes of the present invention, the term “generally spherical” refers to an object, such as a retro-reflective marker sphere covering or a core ball, that is at least 50% spherical in shape over its surface. An object that is generally spherical in shape may include one or more openings and/or recesses. An object that is generally spherical in shape, such as a retro-reflective marker sphere covering, may be comprised of one piece or two or more pieces. An object that is generally spherical in shape may be hollow or solid.

For purposes of the present invention, the term “gold-colored” refers to a bright gold reflective finish. Examples of gold-colored retro-reflective coverings include tapes, inks, paints for cars, bikes and motorcycles, decorative markings for cars, bikes and motorcycles, etc.

For purposes of the present invention, the term “interior snap-on engagement structure” refers to an engagement structure on an interior surface or recess of an object, such as a retro-reflective marker sphere. Examples of interior snap-on engagement structures include the semi-locking interior screw thread shown in FIGS. 10, 11 and 12; the raised rim shown in FIGS. 34 and 39; etc.

For purposes of the present invention, the term “inwardly-directed” refers to a direction extending from the periphery of a structure inwards towards the central axis of the said structure.

For purposes of the present invention, the term “magnetic resonance imaging” (MRI), “nuclear magnetic resonance imaging” (NMRI), or “magnetic resonance tomography” (MRT) refer to a medical imaging technique used in radiology to visualize detailed internal structures. MRI makes use of the property of nuclear magnetic resonance (NMR) to image nuclei of atoms inside the body. An MRI machine uses a powerful magnetic field to align the magnetization of some atomic nuclei in the body, and radio frequency fields to systematically alter the alignment of this magnetization. This causes the nuclei to produce a rotating magnetic field detectable by the scanner. This information is recorded to construct an image of the scanned area of the body. Magnetic field gradients cause nuclei at different locations to rotate at different speeds. By using gradients in different directions 2D images or 3D volumes can be obtained in any arbitrary orientation. MRI provides good contrast between the different soft tissues of the body, which makes it especially useful in imaging the brain, muscles, the heart, and cancers compared with other medical imaging techniques such as computed tomography (CT) or X-rays. Unlike CT scans or traditional X-rays, MRI does not use ionizing radiation.

For purposes of the present invention, the term “manually removable” refers to a pocket layer joined to a backing layer by an adhesive that has a peel strength of no greater than 5 lbs. (22.24 N) of force. In one embodiment of the present invention, a manually removable adhesive may have a peel strength of no greater than 3 lbs. (13.34 N) of force.

For purposes of the present invention, the term “outwardly-directed” refers to a direction extending from the periphery of a structure outwards away the central axis of the said structure.

For purposes of the present invention, the term “polygon” without any modifier refers to both regular and irregular polygons. Similarly, an object that is “polygonal” in shape may be in the shape of a regular or an irregular polygon. For purposes of the present invention, a polygon or an object that is polygonal in shape may have rounded corners.

For purposes of the present invention, the term “predetermined cross-sections” refers to a cross-section that may have any geometrical profile and is not restricted to a particular shape. The pre-determined cross-section may be circular, multi-sided or any other pre-determined geometrical profile.

For purposes of the present invention, the term “proximal” refers to the direction toward the end of a retro-reflective marker sphere where a mounting base of the retro-reflective marker sphere is located, toward the base of a mounting post or toward the end of a medical device that is held by a user or that is used to mount the medical device in place. For purposes of the present invention, the term “distal” refers to the direction opposite the “proximal” direction.

For purposes of the present invention, the term “radially outwardly” refers to moving or extending from structure or region with a symmetrical cross-section on a trajectory along the radial line and away from the center of the said structure or region.

For purposes of the present invention, the term “radiopaque” refers to an object, such as a retro-reflective marker sphere or a core ball, that blocks x-rays or other types of electromagnetic radiation such as UV (ultraviolet) light. A non-radiopaque material, such as a plastic, may be made radiopaque by adding a radiopaque dopant, such as barium, to the material. Examples of radiopaque materials that may be used as dopants to make radiopaque core balls and radiopaque retro-reflective marker spheres of the present invention include calcium phosphate cement, radiopaque polymer salts, iodine agents such as barium sulfate, metal agents such as tantalum, etc.

For purposes of the present invention, the term “relaxed position” refers to a position that flexible engagement structures return to when not subject to external forces.

For purposes of the present invention, the term “releasable engagement” refers to coupling operation between two complementarily shaped structure that can be undone by reversing the motion or the action that caused the coupling to happen. Examples of such as action would be, reversing the direction of the applied force or reversing the relative motion of the structure that caused the coupling.

For purposes of the present invention, the term “resilient material” refers to a material that is deformable by a contacting force, but returns to its original shape thereafter.

For purposes of the present invention, the term “retro-reflective” refers to the conventional meaning of the term “retro-reflective,” i.e., an object or surface that reflects light back to its source with a minimum scattering of light. Retro-reflective materials such as retro-reflective tape and paint may be made in a variety of colors. For example, retro-reflective tapes and materials are commonly used in pavement marking tapes, transport trailer tapes, and safety markers or cones in colors such as white, yellow, red and orange.

For purposes of the present invention, the term “retro-reflective marker sphere” refers to a retro-reflective marker sphere that is retro-reflective and/or has a retro-reflective covering on at least part of the retro-reflective marker sphere. In some embodiments of the present invention, the retro-reflective covering covers at least 95% of the retro-reflective marker sphere.

For purposes of the present invention, the term “right-side-up orientation” refers to a retro-reflective marker sphere oriented in a blister pack so that the proximal end of the retro-reflective marker sphere is adjacent to the backing layer of the blister pack.

For purposes of the present invention, the term “secured configuration” refers to a configuration in which a retro-reflective marker is mounted on a mounting post so that the retro-reflective marker will not move without being externally pulled from the mounting post by a force greater than gravity. Therefore, when mounted in a secured configuration, a retro-reflective marker will not fall off the mounting post on which the retro-reflective marker is mounted when the mounting post is held upside down.

For purposes of the present invention, the term “semi-locking screw thread” refers to a first screw thread which includes a thread that has a ridge that does not fully mate with the groove of a second screw thread that engages the first screw thread.

For purposes of the present invention, the term “shore D hardness” refers to a shore hardness scale which measures the hardness of hard rubber, semi-rigid plastics and hard plastics.

For purposes of the present invention, the term “shore hardness” refers to the durometer scale defined by Albert F. Shore, who developed a measurement device to measure shore hardness.

For purposes of the present invention, the term “single-piece” refers to an object that is made of a single piece, as opposed to being made of two or more pieces.

For purposes of the present invention, the term “snap-fit engagement” refers to interlocking interaction between two or more engagement structure wherein one or more engagement structure engage with and disengage from one or more complementary engagement structures by deforming to slip past or slide over, and springing back into initial form to re-engage thus snapping into engagement.

For purposes of the present invention, the term “snap-on mounting post” refers to a mounting post that is designed to allow a snap-on retro-reflective marker sphere to be snapped onto the mounting post.

For purposes of the present invention, the term “snap-on retro-reflective marker sphere” refers to a retro-reflective marker sphere that snaps onto a mounting post of a medical device. The mounting post may be either a snap-on mounting post or a threaded mounting post. For example, in one embodiment, the present invention provides a retro-reflective marker sphere that is designed to be snapped onto a threaded mounting post.

For purposes of the present invention, the term “stopping contact” or “stop contact” refers to a surface to surface contact between two structures wherein progression or advancement of one structure is impeded or obstructed due to portion of its surface area contacting a portion of a surface of another structure.

For purposes of the present invention, the term “support surface” refers to a surface of a mounting post upon which retro-reflective marker sphere rests when the retro-reflective market sphere is fully and appropriately mounted onto the mounting post.

For purposes of the present invention, the term “threaded mounting post” refers to a mounting post that includes one or more exterior screw threads that is designed to allow a retro-reflective marker sphere with a threaded mounting recess to be screwed onto the mounting post.

For purposes of the present invention, the term “threaded retro-reflective marker sphere” refers to a retro-reflective marker sphere that includes one or more interior screw threads in a mounting recess of the retro-reflective marker sphere.

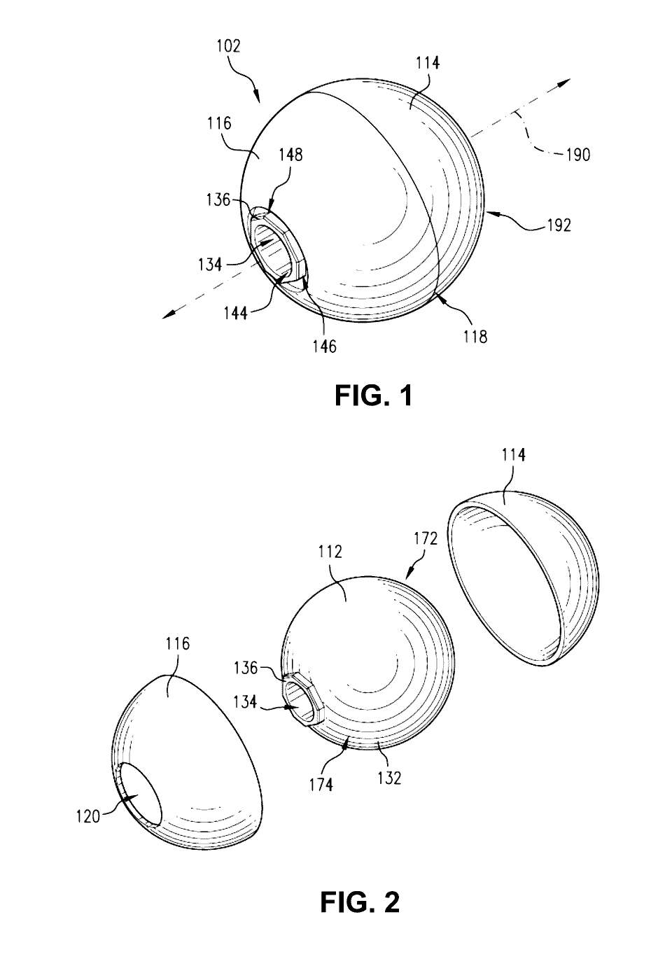

For purposes of the present invention, the term “two-piece retro-reflective covering” refers to a retro-reflective covering that comprises only two pieces. Examples of two-piece retro-reflective coverings are shown in FIGS. 1, 2, 3, 5, 8, 9.

For purposes of the present invention, the term “white-colored” refers to a white finish that reflects light back towards the source of the light. Examples of white-colored retro-reflective coverings include pavement marking tapes, transport trailer tapes, and safety markers or cones.

For purposes of the present invention, the term “x-direction” refers to the direction aligned with the x-axis of a coordinate system.

For purposes of the present invention, the term “y-direction” refers to the direction aligned with the y-axis of a coordinate system.

For purposes of the present invention, the term “z-direction” refers to the direction aligned with the z-axis of a coordinate system.

### DESCRIPTION

Retro-reflective marker spheres, also referred to as passive reflective markers, are widely used in image guidance systems. For example, retro-reflective marker spheres have been used in military, entertainment, sports, and medical applications, and for validation of computer vision and robotics. In filmmaking, retro-reflective marker spheres have been used in recording actions of human actors and using that information to animate digital character models in 2D or 3D computer animation. In motion-capture sessions, movements of one or more actors are sampled many times per second, although with most techniques (recent developments from Weta Digital use images for 2D motion capture and project into 3D), motion capture records only the movements of the actor, not his or her visual appearance. This animation data is mapped to a 3D model so that the model performs the same actions as the actor. This is comparable to the older technique of rotoscope, such as that used in Ralph Bakshi's The Lord of the Rings (1978) and American Pop (1981) animated films in which the motion of an actor was filmed, and then the film was used as a guide for the frame-by-frame motion of a hand-drawn animated character. Camera movements may also be motion captured so that a virtual camera in the scene will pan, tilt, or dolly around the stage driven by a camera operator while the actor is performing, and the motion capture system can capture the camera and props as well as the actor's performance. This allows the computer-generated characters, images and sets to have the same perspective as the video images from the camera. A computer processes the data and displays the movements of the actor, providing the desired camera positions in terms of objects in the set. Retroactively obtaining camera movement data from the captured footage is known as match moving or camera tracking.

In medicine, one-time-use retro-reflective markers spheres are used to aid registration and instrument tracking during image guided surgery procedures such as neurological procedures, spin procedure and orthopedic procedures.

Typically, retro-reflective marker spheres have a high coefficient of retro-reflection on the external surface to provide feedback to the system/camera. These surfaces consist of micro glass spheres that reflect light. However, because medical retro-reflective marker spheres are often used within the sterile field, the spheres may need to be sterilized using processes such as ethylene oxide (ETO) gas sterilization, gamma-ray sterilization and electron beam (E-beam) sterilization. These sterilization processes may negatively impact polymers and may degrade the polymer structure. For this reason, for medical applications, retro-reflective marker spheres may need to be made of materials that are able to withstand the impact of sterilization.

Depending on the medical application, different numbers and arrangements of retro-reflective marker spheres may be mounted on various types of surgical tooling that may be used. For example, from two to five retro-reflective marker spheres may be mounted on a surgical probe. Depending on the type of posts used on a particular surgical probe, each of the retro-reflective marker spheres is mounted on a surgical probes either by screwing the retro-reflective marker sphere onto a threaded mounting post of the surgical probe or by snapping the retro-reflective marker sphere onto a snap-on post of the surgical probe. Once mounted on a surgical problem, retro-reflective marker spheres provide an accuracy reference point for the surgical probe in three-dimensional space.

In one embodiment, the present invention provides a threaded sterile retro-reflective marker sphere that includes a mounting base for improved mounting on a threaded mounting post of a medical device used in image-guided surgical procedures. The retro-reflective marker sphere comprises an interior ball on which are mounted two retro-reflective hemispheres to form a spherical covering. A retro-reflective marker sphere includes a threaded mounting recess in the interior ball at one end into which a threaded mounting post of the medical device extends when the retro-reflective marker sphere is mounted on the medical device. The lower sphere includes an opening aligned with a mounting recess in the interior core ball. Conventionally, the interior screw thread in the mounting recess of a retro-reflective marker sphere is used to determine the point at which the retro-reflective marker sphere is fully mounted on a threaded mounting post. The retro-reflective marker sphere is considered fully mounted when the retro-reflective marker sphere can be turned no more on a threaded mounting post of a medical device. The mounting recess of a conventional retro-reflective marker sphere includes a thread along the entire length of the mounting recess. In contrast, in one embodiment of the present invention, the interior core ball includes a mounting base that extends beyond the edge of the bottom hemisphere so that the mounting base is the only part of the retro-reflective maker sphere that contacts the base of the threaded mounting post. In one embodiment of the present invention, a retro-reflective marker sphere includes a mounting recess having an interior threaded portion to allow the retro-reflective marker sphere to be rapidly and securely snapped onto the threaded mounting post, and a non-threaded portion with structural clearance relative to the mounting post, wherein the internal gaps between inner surface of the recess and the protruding region of the mounting pin ensure that the bottom surface of the retro-reflective marker sphere is the only surface that makes a stop contact with an exterior surface region of the mounting post, thus allowing for accurate alignment and positioning of the retro-reflective marker sphere in the axial direction of the threaded mounting post.

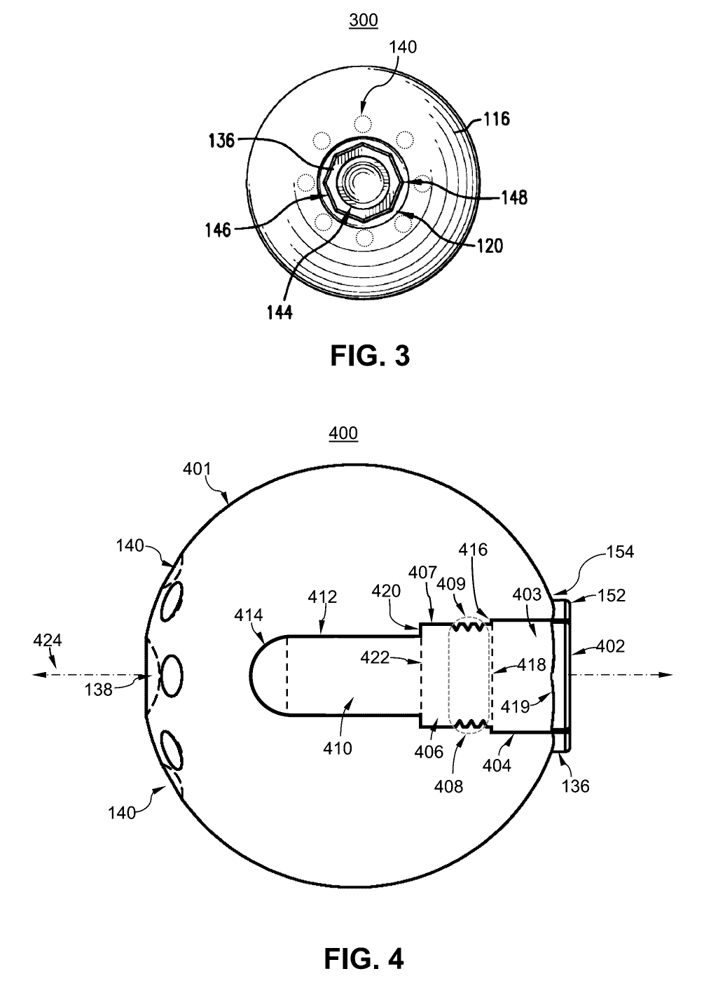

FIGS. 1, 2 and 3 show a retro-reflective marker sphere 102 according to one embodiment of the present invention. Retro-reflective marker sphere 102 comprises a core ball 112 on which is mounted an upper retro-reflective covering piece 114 and a lower retro-reflective covering piece 116. Upper retro-reflective covering piece 114 and lower retro-reflective covering piece 116 are generally hemispherical in shape. Where upper retro-reflective covering piece 114 and lower retro-reflective covering piece 116 meet there is a seam 118. Lower retro-reflective covering piece 116 includes a circular opening 120. Core ball 112, shown from the proximal end in FIG. 3, has a generally spherical body portion 132, a mounting recess 134, a mounting base 136, an upper central circular (dimple) divet and eight upper peripheral circular (dimples) divets 140. Mounting recess 134 is circular in cross-section and has a circular opening 144 centered in mounting base 136. Mounting base 136 may be octagonal in shape, i.e., comprising eight sides 146 and eight corners 148. When assembled, as shown in FIGS. 1, 2, 4 and 5 mounting base 136 extends through circular opening 120 of lower retro-reflective covering piece 116 so that a lower surface 152 of mounting base 136 is spaced proximally from a lower edge 154 of circular opening 120 of lower retro-reflective covering piece 116.

In one exemplary embodiment of the present invention, the mounting recess of the retro-reflective marker sphere 102 extending into the body portion of core ball 112 may comprise one or more recess portions wherein the one or more recess portion may comprise one or more interior flexible engagement structures configured to engage with corresponding exterior engagement structures on a mounting post as the marker sphere is pushed axially down onto the mounting post. In one disclosed embodiment, the aforementioned engagement may include, for example, one or more interior flexible engagement structures configured to snap into and out of engagement with the corresponding exterior engagement structures of the mounting post. The individual interior engagement elements disposed within the mounting recess may be configured to deflect past exterior engagement elements of the mounting post and snap back normal into the adjacent engagement (inter-locking) position. In one embodiment the mounting recess includes flexible interior threads for engaging exterior threads on a mounting post.

In accordance to one aspect of the present invention an audible clicking sound may be generated when thread material deflects and springs back in response to contact pressure from exterior threads of mounting post advancing axially inwards into the mounting recess as further described below. In this way, multiple audible clicks are generated as each interior thread on the threaded portion of the mounting recess deflects past an exterior thread on the threaded mounting post as the retro-reflective marker sphere is pushed down onto the threaded mounting post. The cessation of the audible clicking sound unambiguously indicates to the user that the marker sphere cannot travel further down onto the mounting post at which point the retro-reflective marker sphere is considered fully mounted. In presence of interior recess configuration that allows for optimal snap engagement functionality, the audible clicking feature indicates a clear indication to the user that the retro-reflective marker sphere is fully and securely mounted onto the mounting post thus obviating unnecessary exertion on the part of the user to ensure proper seating and placement. This also indicates accurate and correct alignment of the components for each occurrence of assembly.

In addition to an appropriate dimensional configuration of the recess space and the easy and rapid deployment of retro-reflective marker spheres, disclosed embodiments ensure the secure placement and dimensional stability of retro-reflective marker spheres. This requires that the body portion of the core ball into which the mounting recess extends, is made with soft high-flex material that is hard enough to ensure dimensional stability and secure placement of the marker sphere on the mounting post while being soft enough to allow interior engagement threads to deflect past exterior threads on a mounting post and snap back to normal from the deflected position without shearing off.

In one exemplary embodiment, a preferred material hardness may include a range centered around 55 shore D hardness. To ensure dimensional stability, the hardness is preferably above approximately 45 shore D hardness and, in order to allow the material to snap back easily, the shore D hardness is preferably less than approximately 72 shore D. In one embodiment of the present invention, an optimal shore D hardness value may be selected from a narrower range spanning, for example, between approximately 62 shore D hardness to approximately a 72 shore D hardness rating. In one exemplary embodiment of the present invention, an optimal hardness rating of approximately 68 shore D hardness is selected for the core ball composition material of the retro-reflective marker sphere.

The optimization of physical material properties, such as hardness and flexibility, may facilitate development of retro-reflective spheres with respective engagement structures. For example, disclosed embodiments may include prescribed corrugations or screw threads capable of deforming and snapping back without shearing. Another aspect of the present invention addresses the need for the geometrical configuration and design of the core ball and the mounting recess in order to allow and accommodate the action of the engagement structures.

FIG. 4 illustrates one exemplary embodiment of retro-reflective marker sphere 400 comprising a core ball 401 and a mounting recess 402 having, for example, a circular cross-section. Mounting recess 402 extends into the body portion of the core ball 401. The mounting recess 402 may include a lower recess portion 403 having, for example, a cylindrical wall 404, a middle recess portion 406 having, for example, a cylindrical wall 407 and one or more internal engagement structures 408, for engaging an exterior engagement structures of a mounting post. In the embodiment illustrated in FIG. 4 the interior engagement structure 408 disposed within middle recess portion 406 may comprise a corrugated structure 409 comprising, for example, a plurality of alternating ridges and grooves disposed on a lower portion of the cylindrical wall 407. The mounting recess 402 may further comprise a recess upper portion 410 having, for example, a cylindrical wall 412 and a rounded upper end 414. A circular ledge 416 is formed at a top end 418 of the lower recess portion 403 as a result of the lower recess portion 403 having a larger diameter than the middle recess portion 406. The larger diameter of the lower recess portion 403 may also facilitates easy alignment of the recess opening at the proximal end 419 of the lower recess portion 403 over the mounting post for a quicker and easier deployment. Another circular ledge 420 is formed at a top end 422 of the middle recess portion 406 as a result of the middle recess portion 406 having a larger diameter than the recess upper portion 410. The mounting recess 402 is symmetrical around the axis 424 of the core ball 401 which also extends through the center of mounting recess 402.

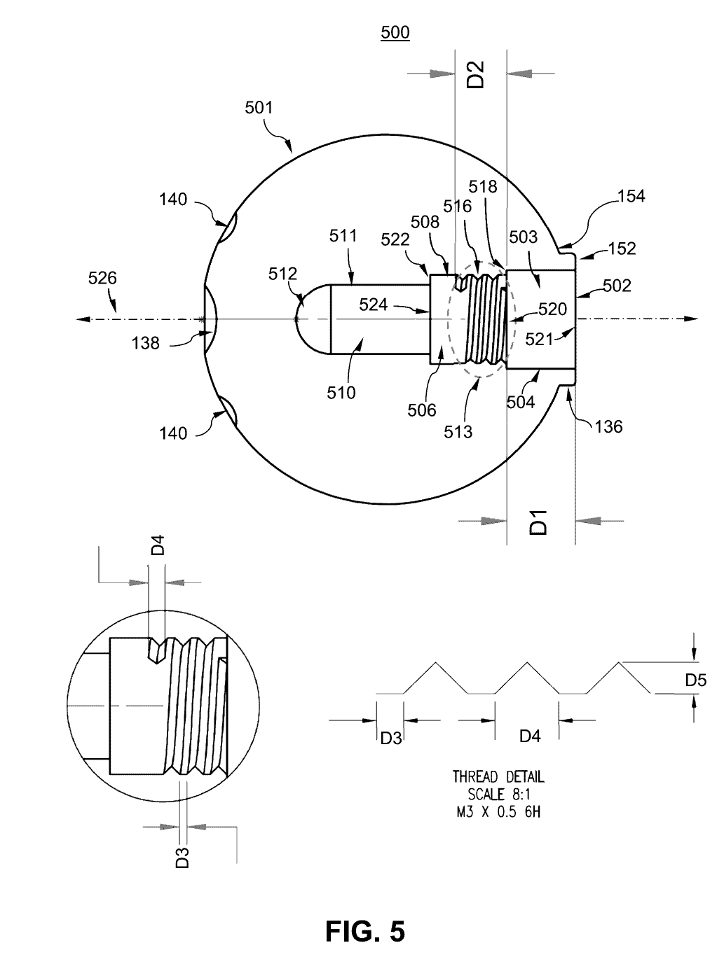

Another exemplary embodiment of the present invention is represented by the retro-reflective sphere 500 as illustrated in FIG. 5. The retro-reflective marker sphere 500 may comprise a core ball 501 and a mounting recess 502 that extends into the body portion of the core ball 501 including, in one exemplary embodiment, a circular cross-section. The mounting recess 502 may include a lower recess portion 503 having, for example, a cylindrical wall 504, a middle recess portion 506 having, for example, a cylindrical wall 508 and one or more interior engagement structures 513 for engaging one or more exterior engagement structures of a mounting post, a recess upper portion 510 having, for example, a cylindrical wall 511 and an upper rounded end 512. In the embodiment illustrated in FIG. 5 the engagement structure 513 disposed within the middle recess portion 506 comprises, for example, a helical pattern of ridges and grooves forming a screw thread 516 on a lower portion of the cylindrical wall 508. Lower recess portion 503 is larger in diameter than middle recess portion 506, thus forming a circular ledge 518 at a distal end 520 of lower recess portion 503. The larger diameter of the lower recess portion 503 may also facilitates easy alignment of the recess opening at the proximal end 521 of the lower recess portion 503 over the mounting post for a quicker and easier deployment. Another circular ledge 522 is formed at a distal end 524 of the middle recess portion 506 as a result of the middle recess portion 506 having a larger diameter than the recess upper portion 510. The mounting recess 502 is symmetrical around the central axis 526 of the core ball 501 which also extends through the center of the mounting recess 502.

FIG. 5 further illustrates the dimensional parameters of the screw thread engagement structure disposed within the recess of the exemplary retro-reflective marker sphere 500 in accordance to the embodiment of the present invention. In the exemplary embodiment of FIG. 5, the height of the non-threaded lower recess portion 503, referenced as parameter D1 therein may be selected from an applicable range approximately spanning from 0.0800 inches to 0.1 inches. In accordance to one exemplary embodiment, parameter D1 may be set to an optimal value of approximately 0.0900 inches. Similarly, the height of the threaded portion 513 of the middle recess portion 506, referenced as parameter D2, may be selected from an applicable range approximately spanning from 0.0570 inches to 0.0770 inches. In accordance to one exemplary embodiment, parameter D2 may be set to an optimal value of approximately 0.0670 inches. Parameter D3 corresponds to a longitudinal separation of adjacent thread ridges which, in accordance to one embodiment of the present invention, may be selected from an applicable range approximately spanning from 0.011 inches to 0.001 inches. Parameter D4 corresponds to a longitudinal height of a single ridge of the screw threaded portion and, in accordance to one embodiment of the present invention, may be selected from a range approximately spanning from 0.0040 inches to 0.0140 inches. Parameter D5 corresponds to a depth of the groove on the internal screw thread engagement structure extending into the mounting recess 502 and, in accordance to one embodiment of the present invention, may be selected from a range approximately spanning from 0.002 inches to 0.012 inches.

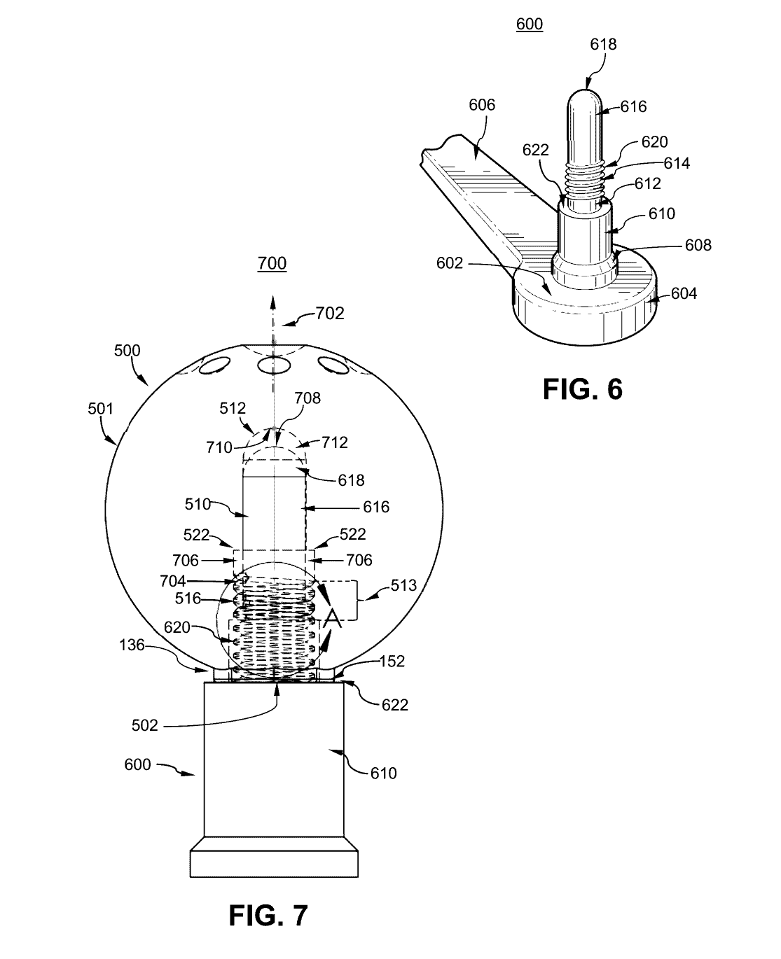

In general, the structure of the disclosed mounting recess extending into the body portion of the core ball in the disclosed retro-reflective marker sphere is designed such that it may be easily and securely mounted onto a mounting post, such as on a surgical probe. FIG. 6 illustrates the general structure of a mounting post. The mounting post 600, as illustrated in FIG. 6, is mounted on an upper surface 602 of a circular end 604 of arm 606 of an exemplary medical device. Mounting post 600 includes a post base 608, a cylindrical post lower portion 610, a post neck portion 612, a post middle portion 614, a cylindrical post upper portion 616 and a post rounded end 618. Post middle portion 614 includes an outwardly-directed screw thread 620. Post lower portion 610 includes an upper support surface 622.

FIG. 7 illustrates the mounted configuration of the retro-reflective marker sphere 500 from FIG. 5 that has been snapped onto the mounting post 600 from FIG. 6. The mounting post 600 is guided into the mounting recess 502 of the core ball 501 through the opening at the proximal end 521 of the lower recess portion 503 that is wider for ease of alignment and positioning relative to the mounting post 600. In the embodiment illustrated in FIG. 7, the engagement structure 513 disposed within the mounting recess 502 of the retro-reflective marker sphere 500 comprises inter-directed flexible screw threads 516 (helical pattern of alternating ridges and grooves) for releasably engaging the exterior screw thread 620 of the mounting post 600 as the retro-reflective marker sphere 500 is pushed axially down onto the mounting post 600 until the lower surface 152 of mounting base 136 abuts upper surface 622 of mounting post lower portion 610. The upper portion 616 and the rounded end 618 of the mounting post 600 are received respectively by the upper portion 510 and rounded upper end 512 of the mounting recess 502 extending into the body portion of core ball 501 in the retro-reflective marker sphere 500. This may help maintain the alignment of retro-reflective marker sphere 500 on mounting post 600 in the direction shown by arrow 702, i.e., the axial direction of the mounting post 600. The structural clearance maintained between the top shoulder 704 of the outwardly-directed screw thread 620 of the mounting post 600 and the circular ledge 522 at the distal end 524 of the middle recess portion 506, when the retro-reflective marker sphere 500 is fully mounted on the threaded mounting post 600, forms the internal gap 706. Similarly, the structural clearance between the top exterior surface 708 of the mounting post upper portion 618 and the top interior surface 710 of the rounded distal end 512 of the recess upper portion 510, when the retro-reflective marker sphere 500 is fully mounted on the threaded mounting post 600, forms the internal gap 712.

Structural protrusions of the mounting post, such as the screw-threaded region comprising protrusions that extend radially outwards and the upper portion of the post that extends axially upwards, comprise the surface regions most likely to make a stop contact with the interior surface of the mounting recess thus obstructing further advancement of the retro-reflective sphere onto the mounting post. Therefore a mounting recess configuration that allows for internal gaps to be maintained between inner surface of the mounting recess and the protruding regions of the mounting post, may ensure that the bottom surface of the retro-reflective marker sphere is the only surface region of the retro-reflective marker sphere that makes a stop contact against an exterior surface region of the mounting post, thus allowing for accurate alignment and positioning of the retro-reflective marker sphere in the axial direction of the threaded mounting post.

In the embodiment illustrated in FIG. 7 the geometrical features of the mounting recess, such as, for example internal gaps 706 and 712 after the retro-reflective marker sphere 500 is fully mounted onto the mounting post 600, ensures that the only stopping contact is between bottom surface 152 of the mounting base 136 and the upper support surface 622 of the mounting post 600, thus allowing for accurate positioning in the y-direction, i.e. the axial direction of the mounting post.

The interior screw threads 516 (longitudinally extending helical pattern of alternating ridges and grooves) disposed on the interior surface of the mounting recess 502 is made from flexible material capable of deforming in response to contact pressure and snapping back to initial form upon sudden loss of contact pressure. The interior screw thread 516 is thus optimized for forming snap-fit engagement with complementary exterior screw threads 620 of the mounting post. As the mounting post is advanced into the mounting recess outwardly-directed screw thread of the mounting post contact and press-against the interior screw thread of the mounting recess. As a flexible interior screw thread deforms in response to the contact pressures from the exterior thread, it deflects and slips past the advancing exterior thread on the mounting post and snaps into engagement with the next succeeding complementary exterior thread, generating an audible clicking sound in the process. Consequently multiple audible clicks are generated as the mounting post extends into the mounting recess of the retro-reflective sphere.

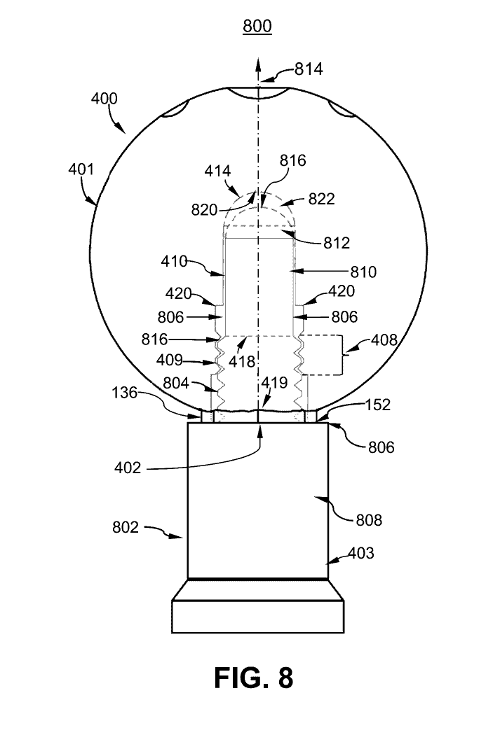

FIG. 8 illustrates the mounted configuration for the retro-reflective marker sphere 400, with an interior corrugated engagement portion 408, comprising plurality of flexible corrugations 409 for snap-on inter-locked engagement with complementary corrugations on a mounting post 802 with a complementary corrugated engagement portion 804, in accordance to one embodiment of the present invention. The mounting post 802 is guided into the mounting recess 402 of the core ball 401 through the opening at the proximal end 419 of the lower recess portion 403 that is wider for ease of alignment and positioning relative to the mounting post 802. In the embodiment illustrated in FIG. 8, the engagement structure 408 disposed within the mounting recess 402 of the retro-reflective marker sphere 400 comprise a inwardly-directed corrugated formation 409 having a plurality of deformable peaks and hollows for detachably engaging the exterior corrugated formation 804 of the mounting post 802 as the retro-reflective marker sphere 400 is driven axially onto the mounting post 802 until the lower surface 152 of mounting base 136 abuts upper support surface 806 of mounting post lower portion 808. The upper portion 810 and the rounded top 812 of the mounting post 802 are received respectively by the upper portion 410 and rounded top end 414 of the mounting recess 402 extending into the body portion of core ball 401 in the retro-reflective marker sphere 400. This may help maintain the alignment of retro-reflective marker sphere 400 on mounting post 802 in the direction shown by arrow 814, i.e., the axial direction of the mounting post 802. The structural clearance between the top shoulder 816 of the outwardly-directed screw thread 804 of the mounting post 802 and the circular ledge 420 at the distal end 422 of the middle recess portion 406, when the retro-reflective marker sphere 400 is fully mounted on the threaded mounting post 802, forms the internal gap 814. Similarly, the structural clearance between the outer top surface 816 of the mounting post upper portion 818 and the top interior surface 820 of the rounded distal end 414 of the recess upper portion 410, when the retro-reflective marker sphere 400 is fully mounted on the threaded mounting post 802, forms the internal gap 822.

The internal gaps between inner surface of the mounting recess, and the protruding regions of the mounting post, ensure that the bottom surface of the retro-reflective marker sphere is the only surface region of the retro-reflective marker sphere that makes a stop contact against an exterior surface region of the mounting post, thus allowing for accurate alignment and positioning of the retro-reflective marker sphere in the axial direction of the threaded mounting post. In the embodiment illustrated in FIG. 8 the geometrical design of the mounting recess, that, for example, allows for internal gaps 806 and 822, ensure that the only stopping contact is between bottom surface 152 of the mounting base 136 and the upper support surface 806 of the mounting post 802, thus allowing for accurate positioning in the y-direction i.e. the axial direction of the mounting post.

The corrugated formation 409 disposed on the interior surface of the mounting recess 402 is made from flexible material capable of deforming in response to contact pressure from another structure pressing against it, and snapping back to initial form upon sudden loss of contact pressure. The interior corrugations 409 are thus optimized for forming snap-fit engagement with complementary exterior corrugations 804 of the mounting post. As the mounting post is advanced into the mounting recess, outwardly-directed corrugations of the mounting post contact and press-against the inwardly-directed corrugations of the mounting recess. As a flexible interior corrugation on the interior of the mounting recess deforms in response to contact pressures from an exterior corrugation on the mounting post, it deflects and slips past the advancing exterior corrugation and snaps into detachable inter-locking engagement with the next succeeding complementary exterior corrugation, generating an audible clicking sound in the process. Consequently multiple audible clicks are generated as the mounting post extends into the mounting recess of the retro-reflective sphere.

In order to facilitate quick and reliable deployment of the retro-reflective marker sphere the geometrical design of the core ball must be optimized such that appropriate gaps are maintained between interior structural members of the mounting recess and exterior structural members of the mounting post, in accordance to the structural relationship that may exist between the said members. This process not only involves preventing obstructive contact between non-engaging surfaces by designing for necessary clearance spaces and internal gaps, but also requires providing sufficient contact between engaging complementary surfaces on the interior of the mounting recess and exterior of the mounting post such that, for example, reliable releasable interlocking can occur between engaging members of the mounting recess and the mounting post.

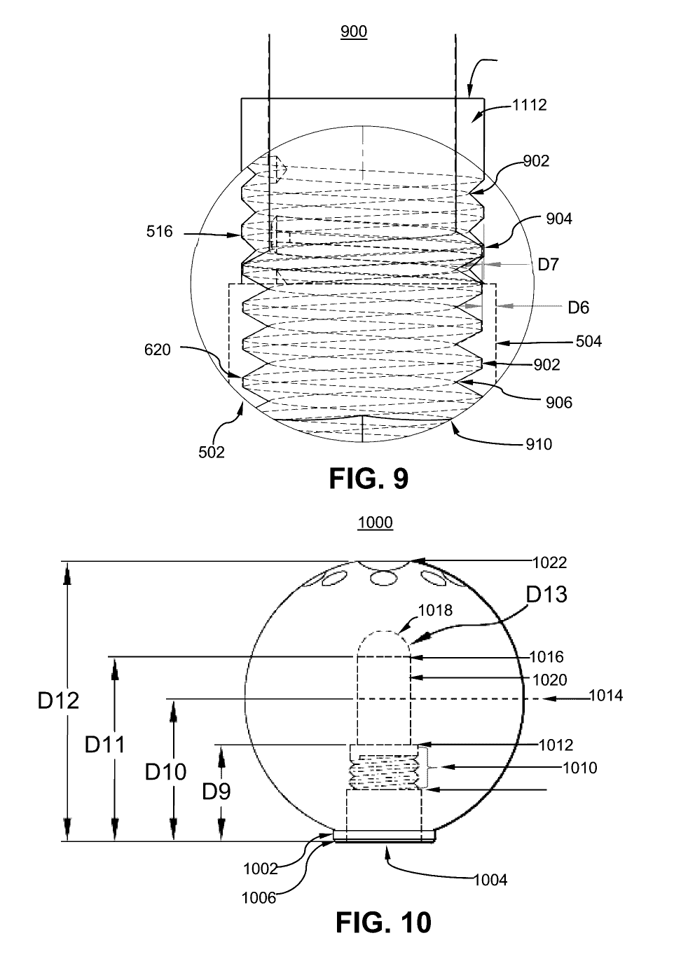

FIG. 9, corresponding to a close-up view 900 of the circled region A in FIG. 7, illustrates one exemplary embodiment of dimensional requirements for maintaining appropriate structural overlaps and clearance between interior and exterior features in a portion of an exemplary mounting recess structure. In FIG. 9 the flexible interior screw thread 516, disposed in the mounting recess 502 of the retro-reflective marker sphere 500, is shown in a detachable interlocking engagement with exterior screw thread 620 of mounting post 600, in accordance to one embodiment of the present invention. Parameter D6, denoted on FIG. 9, represents the separation gap maintained between a protruding structural member of the mounting post corresponding to tip 902 of the exterior screw thread 620 and the interior wall 504 of the lower recess portion 502. Since structure 620 and structure 504 are not meant to engage one another, the structural clearance gap D6 is designed to ensure no physical interaction such as, for example, surface contact or stop contact, between structure 620 and structure 504. In the exemplary embodiment of FIG. 9, the clearance gap D6 may be selected from an applicable range approximately spanning from 0.0017 inches to 0.0117 inches. In accordance to one exemplary embodiment, parameter D6 may be set to an optimal value of approximately 0.0067 inches. Parameter D7, denoted on FIG. 9, represents the separation gap maintained between the tip 902 of the exterior screw thread 620 and the tip 904 of the complementary interior screw thread 516. Since structure 516 is an interior complementary engagement structure to structure 620, the structural separation gap D2 is designed to ensure appropriate physical interaction such as, for example, releasable interlocking engagement between structure 620 and structure 516. In the exemplary embodiment of FIG. 9, parameter D6 may be set to an optimal value of approximately 0.0007 inches.

FIG. 10 illustrates geometrical parameters of a retro-reflective marker sphere core ball 1000 comprising a mounting base 1002 and a mounting recess 1004 that extends into the body portion of the core ball 1000 and is designed for maintaining appropriate structural clearance distances and internal gaps between the inner surface of the mounting recess 1004 and the outer surface of a mounting post, for example mounting post 600, after retro-reflective marker sphere is fully mounted onto the mounting post, in accordance to one embodiment of the present invention. Parameter D9, denoted in FIG. 10, represents the height extending from the bottom surface 1006 of the mounting base 1002 up to the top surface 1008 of the middle recess portion 1010. In the exemplary embodiment of FIG. 10, the height D9 may be selected from an applicable range approximately spanning from 0.16 inches to 0.18 inches. In accordance to one exemplary embodiment, parameter D9 may be set to an optimal value of approximately 0.17 inches. Parameter D10, denoted in FIG. 10, represents the height extending from the bottom surface 1006 of the mounting base 1002 up to the mold parting line of the retro-reflective sphere corresponding to the mid-line 1014 of the core ball 1000. In the exemplary embodiment of FIG. 10, the height D10 may be selected from an applicable range approximately spanning from 0.242 inches to 0.252 inches. In accordance to one exemplary embodiment, parameter D10 may be set to an optimal value of approximately 0.247 inches. Parameter D11, denoted in FIG. 10, represents the height extending from the bottom surface 1006 of the mounting base 1002 up to where the top of the mounting post may extend to, corresponding to a base 1016 of the rounded top 1018 of the recess upper portion 1020. In the exemplary embodiment of FIG. 10, the height D11 may be selected from an applicable range approximately spanning from 0.31 inches to 0.33 inches. In accordance to one exemplary embodiment, parameter D11 may be set to an optimal value of approximately 0.32 inches. Parameter D12, denoted in FIG. 10, represents the height extending from the bottom surface 1006 of the mounting base 1002 up to the top 1022 of the core ball 1000. In the exemplary embodiment of FIG. 10, the height D12 may be selected from an applicable range approximately spanning from 0.4748 inches to 0.4898 inches. In accordance to one exemplary embodiment, parameter D12 may be set to an optimal value of approximately 0.4848 inches. Parameter D13, denoted in FIG. 10 represents the cross-sectional diameter of the rounded top end 1018 of the recess upper portion 1020. In the exemplary embodiment of FIG. 10, the length D13 may be selected from an applicable range approximately spanning from 0.0806 inches to 0.1006 inches. In accordance to one exemplary embodiment, parameter D13 may be set to an optimal value of approximately 0.0906 inches.

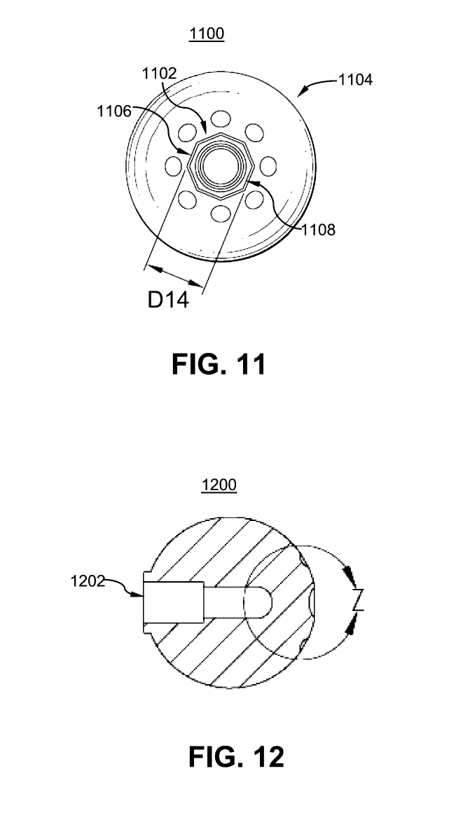

FIG. 11 illustrates the bottom view 1100 of the mounting base 1102 of the retro-reflective marker sphere 1104, in accordance to one aspect of the present invention. Parameter D14, denoted on FIG. 11, represents the length of the inside diameter of the octagonal mounting base 1102 which corresponds to the distance between any two opposite edges, for example edge 1106 and edge 1108, of the mounting base 1102. In the exemplary embodiment of FIG. 11, the length D14 may be selected from an applicable range approximately spanning from 0.155 inches to 0.165 inches. In accordance to one exemplary embodiment, parameter D14 may be set to an optimal value of approximately 0.160 inches.

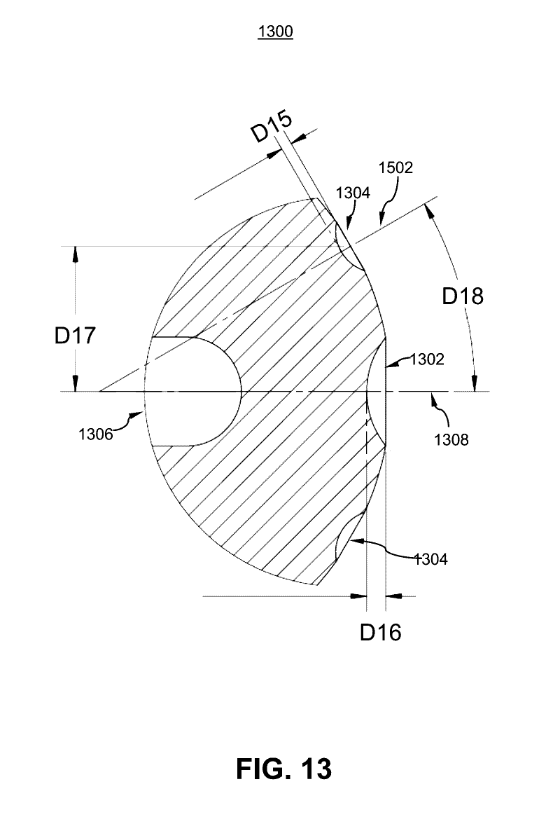

FIG. 13 illustrates a detailed view 1300 of the circled region Z in FIG. 14 comprising the central divet 1302 and peripheral divets 1304 and a portion 1306 of the mounting recess 1202. In one exemplary embodiment of the present invention, a maximum of approximately eight divets may be provided. Parameters D15, D16, D17 and D18, denoted in FIG. 13, respectively represent depth of the dimple corresponding to central divet 1302, depth of the dimple corresponding to peripheral divet 1304, horizontal displacement of peripheral divets 1304 from the central axis 1308 and angular separation of peripheral divets 1304 from the central axis 1308. In the exemplary embodiment of FIG. 13 parameter D15 may be selected from an approximate range extending from 0.0099 inches to 0.0101 inches. In accordance to one exemplary embodiment, parameter D15 may be set to an optimal value of approximately 0.01 inches. In the exemplary embodiment of FIG. 13, parameter D16 may be selected from an approximate range extending from 0.018 inches to 0.022 inches. In accordance to one exemplary embodiment, parameter D16 may be set to an optimal value of approximately 0.02 inches. In the exemplary embodiment of FIG. 13, parameter D17 may be approximately set to 0.120 inches and parameter D18 may be approximately set to 30.00 degrees. It should be noted that disclosed parameter values and ranges correspond to exemplary embodiments of the present invention and not meant to restrict the scope of the present invention.

Having described the many embodiments of the present invention in detail, it will be apparent that modifications and variations are possible without departing from the scope of the present invention defined in the appended claims. Furthermore, it should be appreciated that all examples in the present disclosure, while illustrating many embodiments of the present invention, are provided as non-limiting examples and are, therefore, not to be taken as limiting the various aspects so illustrated.

While the present invention has been disclosed with references to certain embodiments, numerous modifications, alterations and changes to the described embodiments are possible without departing from the scope and spirit of the present invention, as defined in the appended claims. Accordingly, it is intended that the present invention not be limited to the described embodiments, but that it have the full scope defined by the language of the following claims, and equivalents thereof.

What is claimed is:

1. A device comprising a retro-reflective marker comprising:
a core comprising:
a body portion, and
a mounting recess extending into the body portion,
wherein the mounting recess comprises one or more flexible interior engagement structures configured for snap-on engagement with one or more complementary exterior engagement structures of a mounting post,
wherein the flexible interior engagement structures are configured so that when the retro-reflective marker is mounted onto the mounting post by direct axial application, the flexible interior engagement structures are deflected by the one or more complementary exterior engagement structures as the flexible interior engagement structures move past the one or more complementary exterior engagement structures and spring back to a relaxed position to thereby engage the one or more complementary exterior engagement structures so that the retro-reflective marker is mounted in a secured configuration on the mounting post.

2. The device of claim 1, wherein the flexible interior engagement structures have a hardness rating of from about 55 shore D to about 77 shore D.

3. The device of claim 1, wherein the flexible interior engagement structures have a hardness rating of from about 63 shore D to about 73 shore D.

4. The device of claim 1, wherein the flexible interior engagement structures have a hardness rating of about 68 shore D.

5. The device of claim 1, wherein the one or more complementary exterior engagement structures comprise one or more exterior snap-on exterior engagement structures, and wherein the flexible interior engagement structures comprise interior snap-on engagement structures that are configured to engage the one or more exterior snap-on exterior engagement structures when the retro-reflective marker is mounted in a secured configuration on the mounting post.

6. The device of claim 1, wherein the one or more complementary exterior engagement structures comprise complementary corrugated exterior engagement structures, and wherein the flexible interior engagement structures comprise a plurality of alternating annular ridges and grooves that are configured to engage the complementary corrugated exterior engagement structures when the retro-reflective marker is mounted in a secured configuration on the mounting post.

7. The device of claim 1, wherein the one or more complementary exterior engagement structures comprise an exterior complementary screw thread portion, and wherein the flexible interior engagement structures comprise an interior screw threaded portion having a helical pattern of alternating ridges and grooves that are configured to snap-engage the exterior complementary screw thread portion when the retro-reflective marker is mounted in a secured configuration on the mounting post.

8. A device comprising a retro-reflective marker comprising:
a core comprising:
a body portion, and
a mounting recess extending into the body portion of the core,
wherein the mounting recess comprises one or more flexible snap-on interior engagement structures configured to releasably engage one or more complementary exterior engagement structures of a mounting post when the retro-reflective marker is in a secured configuration on the mounting post,
wherein releasable engagement of one or more interior engagement structures of the mounting recess with one or more complementary exterior engagement structures of the mounting post generates an audible clicking sound,
wherein multiple audible clicks are generated as the mounting post axially extends into the mounting recess, and
wherein, cessation of the audible clicking sound indicates that the retro-reflective marker is in a secured configuration on the mounting post.

9. The device of claim 8, wherein the one or more complementary exterior engagement structures comprise an exterior complementary corrugated structure, and wherein the flexible snap-on interior engagement structures comprise a corrugated structure having a plurality of alternating annular ridges and grooves configured to engage the exterior complementary corrugated structure when the retro-reflective marker is mounted in a secured configuration on the mounting post.

10. The device of claim 8, wherein the one or more complementary exterior engagement structures comprise an exterior complementary screw threaded structure, and wherein the flexible snap-on interior engagement structures comprise a screw threaded structure having a helical pattern of alternating ridges and grooves configured to snap-engage the exterior complementary screw threaded structure when the retro-reflective marker is mounted in a secured configuration on the mounting post.

11. A device comprising a retro-reflective marker comprising:
a core comprising:
a body portion, and
a mounting recess extending into the body portion of the core,
wherein the mounting recess comprises one or more interior engagement structures configured to releasably engage one or more complementary exterior engagement structures of a mounting post when the retro-reflective marker is in a secured configuration on the mounting post,
wherein the mounting recess comprises internal gaps between one or more interior surface regions of the mounting recess and one or more protruding surface regions of a mounting post when the retro-reflective marker is mounted in the secured configuration on the mounting post, and
wherein the retro-reflective marker and the mounting post have a stop contact between a bottom surface of the retro-reflective marker and a support surface of the mounting post and this is the only stop contact between the retro-reflective marker and the mounting post.

12. The device of claim 11, wherein the mounting recess comprises a lower recess portion, a middle recess portion and a recess upper portion, wherein the lower recess portion is non-threaded and larger in diameter than the middle recess portion, thereby forming a ledge structure at an upper end of the lower recess portion, wherein the middle recess portion comprises a threaded portion and a non-threaded portion and wherein the middle recess portion is larger in diameter than the recess upper portion, thereby forming a ledge structure at an upper end of the middle recess portion, wherein the recess upper portion is non-threaded.

13. The device of claim 12, wherein the one or more complementary exterior engagement structures comprise a mounting post thread and wherein a peripheral clearance between a crest of a mounting post thread and an inner periphery wall of the lower recess portion is about 0.0067 inches.

14. The device of claim 12, wherein the one or more complementary exterior engagement structures comprise a mounting post thread and wherein a peripheral clearance between a crest of the threaded portion of the middle recess portion and a root of the mounting post thread is about 0.0007 inches.

15. The device of claim 12, wherein the threaded portion of the middle recess portion has a thread depth of about 0.007 inches with a tolerance of approximately 0.005 inches.

16. The device of claim 12, wherein the threaded portion of the middle recess portion has a thread height of about 0.0670 inches.

17. The device of claim 12, a thread root of the threaded portion of the middle recess portion has a has a flattened tip of about 0.006 inches in length with a tolerance of approximately 0.005 inches.

18. The device of claim 12, wherein the threaded portion of the middle recess portion has a thread pitch of about 0.014 inches with a tolerance of about 0.005 inches.

19. The device of claim 12, wherein the distance from a bottom surface of a mounting base of the mounting post to a top of the middle recess portion is from about 0.016 inches to about 0.018 inches.

20. The device of claim 12, wherein a distance from a bottom surface of a mounting base of the mounting post to an equatorial plane of the retro-reflective marker is from about 0.242 inches to about 0.252 inches.

21. The device of claim 12, wherein a distance from a bottom surface of a mounting base of the mounting post to a top of the recess upper portion is from about 0.31 inches to about 0.33 inches.

22. The device of claim 12, wherein a distance from a bottom surface of a mounting base of the mounting post to and equatorial plane of the retro-reflective marker is from about 0.242 inches to about 0.252 inches.

23. The device of claim 12, wherein a cross-sectional diameter of the recess upper portion is from about 0.0806 inches to about 0.1006 inches.

24. The device of claim 11, wherein a mounting base of the mounting post has a polygonal cross-section, with even number of edges, in a plane perpendicular to an axis of the core and wherein the distance between opposing sides of a mounting base of the mounting post is from about 0.155 inches to about 0.165 inches.

25. The device of claim 11, wherein retro-reflective sphere cross-sectional diameter is from about 0.481 inches to about 0.487 inches.

26. The device of claim 11, wherein retro-reflective sphere cross-sectional diameter is from about 0.481 inches to about 0.487 inches.
